(19) United States
(12) Patent Application Publication
(10) Pub. No.: US 2026/0040369 A1
(43) Pub. Date: Feb. 5, 2026

(54) TECHNIQUES FOR SELECTING A PREAMBLE FORMAT

(71) Applicant: Lenovo (United States) Inc., Morrisville, NC (US)

(72) Inventors: Karthikeyan Ganesan, Nauheim (DE); Ravi Kuchibhotla, Chicago, IL (US); Ali Ramadan Ali, Kraiburg am Inn (DE)

(21) Appl. No.: 19/358,012

(22) Filed: Oct. 14, 2025

(51) Int. Cl. H04W 74/0833; H04B 17/318; H04W 72/21

(52) U.S. Cl. CPC H04W 74/0833; H04B 17/328; H04W 72/21

(57) ABSTRACT

Various aspects of the present disclosure relate to receiving a configuration message for random access channel (RACH) transmission, the configuration message comprising a plurality of RACH configuration indices and a set of thresholds; selecting a first RACH configuration index based on a comparison of at least one reference signal measurement to the set of thresholds; and transmit, to a base station, a first RACH preamble having a preamble format based on the first RACH configuration index, wherein the preamble format comprises a long preamble format for extended coverage or a short preamble for basic coverage.

### TECHNICAL FIELD

The present disclosure relates to wireless communications, and more specifically to techniques for selecting a preamble format for a random-access channel (RACH) preamble transmission.

### BACKGROUND

A wireless communications system may include one or multiple network communication devices, which may be known as a network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies (RATs) including third generation (3G) radio access technology, fourth generation (4G) radio access technology, fifth generation (5G) radio access technology, among other suitable radio access technologies beyond 5G (e.g., 5G-Advanced (5G-A), sixth generation (6G) radio access technology, etc.).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of””) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The devices (e.g., NE, UE), processors, and methods of the present disclosure each have several innovative aspects, no single one of which is solely responsible for the desirable features disclosed herein.

A UE for wireless communication is described. The UE may be configured to, capable of, or operable to cause the UE to receive a configuration message for random access channel (RACH) transmission, the configuration message including a plurality of RACH configuration indices and a set of thresholds; select a first RACH configuration index based on a comparison of at least one reference signal measurement to the set of thresholds; and transmit, to a base station, a first RACH preamble having a preamble format based on the first RACH configuration index, where the preamble format includes a long preamble format for extended coverage or a short preamble for basic coverage.

A processor for wireless communication is described. In certain implementations, the processor may implement, or may be implemented by, a UE. The processor may be configured to, capable of, or operable to receive a configuration message for RACH transmission, the configuration message including a plurality of RACH configuration indices and a set of thresholds; select a first RACH configuration index based on a comparison of at least one reference signal measurement to the set of thresholds; and transmit, to a base station, a first RACH preamble having a preamble format based on the first RACH configuration index, where the preamble format includes a long preamble format for extended coverage or a short preamble for basic coverage.

A method performed or performable by a UE is described. The method may include receiving a configuration message for RACH transmission, the configuration message including a plurality of RACH configuration indices and a set of thresholds; selecting a first RACH configuration index based on a comparison of at least one reference signal measurement to the set of thresholds; and transmitting, to a base station, a first RACH preamble having a preamble format based on the first RACH configuration index, where the preamble format includes a long preamble format for extended coverage or a short preamble for basic coverage.

A base station for wireless communication is described. The base station may be configured to, capable of, or operable to cause the base station to transmit a configuration message for RACH transmission, the configuration message including a plurality of RACH configuration indices and a set of thresholds; transmit one or more reference signals; and receive, from a UE, a first RACH preamble having a preamble format associated with a first RACH configuration index and based on at least one reference signal measurement and the set of thresholds, where the preamble format includes a long preamble format for extended coverage or a short preamble for basic coverage.

A processor for wireless communication is described. The processor may be configured to, capable of, or operable to transmit a configuration message for RACH transmission, the configuration message including a plurality of RACH configuration indices and a set of thresholds; transmit one or more reference signals; and receive, from a UE, a first RACH preamble having a preamble format associated with a first RACH configuration index and based on at least one reference signal measurement and the set of thresholds, where the preamble format includes a long preamble format for extended coverage or a short preamble for basic coverage.

A method performed or performable by a base station is described. The method may include transmitting a configuration message for RACH transmission, the configuration message including a plurality of RACH configuration indices and a set of thresholds; transmitting one or more reference signals; and receiving, from a UE, a first RACH preamble having a preamble format associated with a first RACH configuration index and based on at least one reference signal measurement and the set of thresholds, where the preamble format includes a long preamble format for extended coverage or a short preamble for basic coverage.

### BRIEF DESCRIPTION OF THE DRAWINGS

FIG. 1 illustrates an example of a wireless communications system in accordance with aspects of the present disclosure.

FIG. 2 illustrates an example of a RACH procedure supporting multiple RACH occasions (ROs), in accordance with aspects of the present disclosure.

FIG. 3A illustrates a first example of RACH resource allocations, in accordance with aspects of the present disclosure.

FIG. 3B illustrates a second example of RACH resource allocations, in accordance with aspects of the present disclosure.

FIG. 3C illustrates a third example of RACH resource allocations, in accordance with aspects of the present disclosure.

FIG. 4 illustrates an example of system for coverage based on reference signal received power (RSRP), in accordance with aspects of the present disclosure.

FIG. 5 illustrates an example of transmission scheme for slot bundling a larger transport block (TB), in accordance with aspects of the present disclosure.

FIG. 6 illustrates an example of a protocol stack, in accordance with aspects of the present disclosure.

FIG. 7 illustrates an example of a UE, in accordance with aspects of the present disclosure.

FIG. 8 illustrates an example of a processor, in accordance with aspects of the present disclosure.

FIG. 9 illustrates an example of a NE, in accordance with aspects of the present disclosure.

FIG. 10 illustrates a flowchart of a method performed by a UE in accordance with aspects of the present disclosure.

FIG. 11 illustrates a flowchart of a method performed by a NE in accordance with aspects of the present disclosure.

### DETAILED DESCRIPTION

A wireless communication network, including one or more wireless devices, nodes, network entities, etc., may support a random-access procedure for cell access, referring to a process for establishing an initial connection between UE and radio access network (RAN) that aligns timing, identifies the UE, and—if needed—allocates uplink (UL) resources. The random-access procedure may be contention-based or contention-free, optionally enhanced by 2-step low-latency variants.

In a 5G new radio (NR) system, the RACH procedure provides the mechanism by which a UE establishes UL synchronization and initiates communication with the serving base station (e.g., a next-generation Node B (gNB)). The RACH procedure enables the network to determine and correct the UE's timing alignment, assign temporary identifiers, and allocate UL transmission resources, ensuring that multiple UEs can share the same spectrum without mutual interference. The RACH design in 5G NR supports both contention-based and contention-free operation, allowing efficient access for a wide range of use cases including initial access, beam recovery, and handover.

To improve UL coverage-particularly for UEs at cell edges or operating under weak signal conditions-a RACH configuration may require the UE to transmit repetitions of the random access preamble across multiple time-frequency occasions. These repetitions increase the probability that the gNB can detect at least one instance of the preamble despite noise, fading, or interference. However, bandwidth-limited UEs face challenges in supporting enhanced coverage features and may be unable to transmit across the full configured RACH bandwidth or to perform parallel repetitions efficiently, resulting in reduced reliability and increased access delay.

Although RACH preamble (RAP) repetitions and Msg3 repetitions offer a mechanism to improve UL coverage, the 5G RACH procedure was not designed to support coverage enhancements for Msg3 and there are no reserved bits in the random access response (RAR) message to transmit the information related to number of repetitions. Given that 6G systems are expected to support a wide variety of device types, the lowest code rate may need more time domain resource with limited frequency domain resource for the bandwidth limited UEs.

The present disclosure describes procedures for selecting preamble format, Msg3 code rate, repetitions and slot bundling and combination thereof enabling contention-based UL access as an alternative to conventional grant-based UL scheduling. In various implementations, a bandwidth limited UE or a UE requiring extended coverage may implement slot bundling to transmit Msg3 physical uplink shared channel (PUSCH).

In some implementations, a UE may be configured with information for determining the type of RACH preamble to use, e.g., based on supported bandwidth and/or required coverage. For example, the UE may be configured with multiple RACH configurations and also with one or more selection criteria for selecting a particular RACH configuration. In certain implementations, the UE may select the preamble characteristics and/or Msg3 characteristics based on a measured signal strength or signal quality.

While presented as distinct solutions, one or more of the solutions described herein may be implemented in combination with each other. Aspects of the present disclosure are described in the context of a wireless communications system.

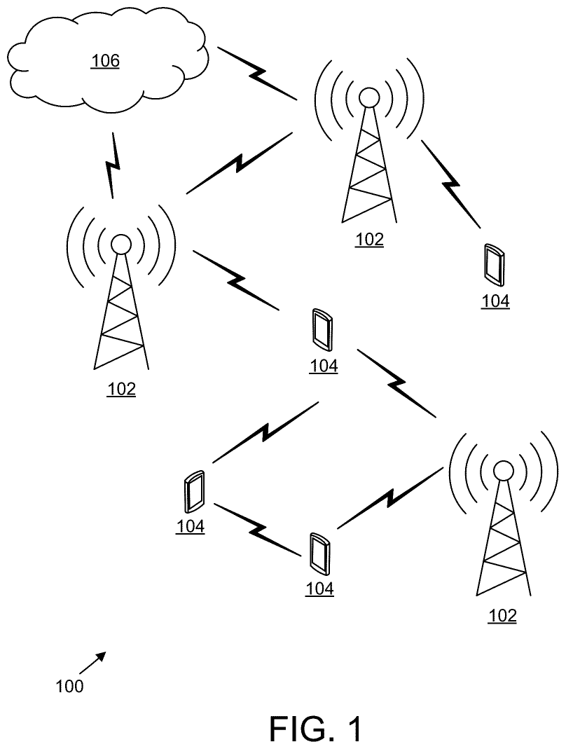

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various RATs. In some implementations, the wireless communications system 100 may be a 4G network, such as a long-term evolution (LTE) network or an LTE-Advanced (LTE-A) network. In some other implementations, the wireless communications system 100 may be a new radio (NR) network, such as a 5G network, a 5G-Advanced (5G-A) network, or a 5G ultrawideband (5G-UWB) network. In some other implementations, the wireless communications system 100 may be a 6G radio (6GR) network, such as a 6G network. In other implementations, the wireless communications system 100 may be a combination of a 4G network and/or a 5G network and/or a 6G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6GR. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a wireless communication network entity, a RAN, a RAN entity, a NodeB, an eNodeB (eNB), a gNB, or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an internet-of-things (IoT) device, an internet-of-everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing (SCS) value and a cyclic prefix. A first numerology (e.g., μ=0) may be associated with a first SCS value (e.g., 15 kHz) and a normal cyclic prefix. In some implementations, the first numerology (e.g., μ=0) associated with the first SCS value (e.g., 15 kHz) may utilize one slot per subframe. A second numerology (e.g., μ=1) may be associated with a second SCS value (e.g., 30 kHz) and a normal cyclic prefix. A third numerology (e.g., μ=2) may be associated with a third SCS value (e.g., 60 kHz) and a normal cyclic prefix or an extended cyclic prefix. A fourth numerology (e.g., μ=3) may be associated with a fourth SCS value (e.g., 120 kHz) and a normal cyclic prefix. A fifth numerology (e.g., μ=4) may be associated with a fifth SCS value (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective SCS values of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz SCS), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first SCS value (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations frequency range #1 (FR1) (e.g., 410 MHz-7.125 GHZ), frequency range #2 (FR2) (e.g., 24.25 GHz-52.6 GHz), frequency range #3 (FR3) (e.g., 7.125 GHZ-24.25 GHz), frequency range #4 (FR4) (e.g., 52.6 GHz-114.25 GHZ), frequency range #4a (FR4a) or frequency range #4-1 (FR4-1) (e.g., 52.6 GHz-71 GHZ), and frequency range #5 (FR5) (e.g., 114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz SCS; a second numerology (e.g., μ=1), which includes 30 kHz SCS; and a third numerology (e.g., μ=2), which includes 60 kHz SCS. FR2 may be associated with one or multiple numerologies (e.g., at least 2 numerologies). For example, FR2 may be associated with a third numerology (e.g., μ=2), which includes 60 kHz SCS; and a fourth numerology (e.g., μ=3), which includes 120 kHz SCS.

According to implementations, one or more of the NEs 102 and the UEs 104 are operable to implement various aspects of the techniques described with reference to the present disclosure.

In some implementations, an NE 102 may transmit, and a UE 104 may receive, transmit a configuration message for RACH transmission (also referred to herein as a “RACH configuration”), the configuration message comprising a plurality of RACH configuration indices and a set of thresholds. For example, the NE 102 may provide the RACH configuration in one or more radio resource control (RRC) messages using RRC signaling. As another example, the NE 102 may broadcast minimum system information comprising the configuration message, such that the UE 104 receives the RACH configuration by receiving the minimum system information. The minimum system information refers to the essential subset of broadcast information that a UE must acquire to begin communicating with a cell.

In some implementations, the NE 102 may transmit one or more reference signals, and the UE 104 may perform at least one reference signal measurement based on at least one received reference signal. For example, the at least one reference signal measurement may include a RSRP measurement. Based on a comparison of the at least one reference signal measurement to the set of thresholds, the UE 104 may select a first RACH configuration index based on a comparison of at least one reference signal measurement to the set of thresholds.

In some implementations, the UE 104 may transmit, and the NE may receive, a first RACH preamble having a preamble format based on the first RACH configuration index, wherein the preamble format comprises a long preamble format for extended coverage or a short preamble for basic coverage. As used herein, extended coverage refers to broad (i.e., far-reaching) coverage which typically use lower-frequency radio bands (e.g., sub-1 GHz frequency bands). As such, extended coverage may be characterized by lower throughput (i.e., lower data speeds) and more reliable connectivity. In contrast, the term “basic coverage,” as used herein, refers to coverage areas supporting high-speed communications, which typically use higher-frequency radio bands (e.g., 1 GHz and higher frequency bands) with higher frequencies supporting faster speeds and lower latency as the cost of reduced range.

In certain implementations, the UE 104 may also select, based at least in part on the at least one reference signal measurement, a number of repetition counts associated with transmission of the first RACH preamble. Accordingly, the UE 104 may also repeat transmission of the first RACH preamble based on the selected number of repetition counts. Upon receiving the first RACH preamble, the NE 102 may transmit a RAR message to the UE 104.

In some implementations, the UE 104 may determine a code rate for a PUSCH transmission associated with the first RACH preamble, such as a RACH message 3 (Msg3) or a RACH message A (MsgA), and may perform the PUSCH transmission (i.e., RACH Msg3 or RACH MsgA) over multiple slots using a slot bundling technique in response to the code rate satisfying a rate threshold. In certain implementations, the code rate is selected based on the at least one reference signal measurement.

For initial access, a UE 104 detects a candidate cell and performs downlink (DL) synchronization. For example, the NE 102 (e.g., a gNB) may transmit a synchronization signal and physical broadcast channel (SS/PBCH) transmission, also referred to as a synchronization signal block (SSB), consisting of the primary synchronization signal (PSS), the secondary synchronization signal (SSS), and the physical broadcast channel (PBCH) (e.g., carrying the master information block (MIB)). The synchronization signal (e.g., PSS and SSS) is a predefined data sequence known to the UE 104 (or derivable using information already stored at the UE 104) and is in a predefined location in time relative to frame/subframe boundaries, etc. The UE 104 searches for the SSB and uses the SSB to obtain DL timing information (e.g., symbol timing) for the DL synchronization. The UE 104 may also decode system information (SI) based on the SSB. Note that with beam-based communication, each DL beam may be associated with a respective SSB. For 5G NR, the starting symbols and number of SSB blocks as function of system carrier frequency and SCS are defined in 3GPP technical specification (TS) 38.213.

During the DL synchronization step, the NE 102 may transmit a SSB burst, e.g., periodically. In beam-based communication, the UE 104 may measure and then select the Tx and Rx beam pair indices associated with the best SSB. In certain embodiments, the UE 104 uses the PSS to synchronize in the frequency domain and uses the SSS to synchronize in the time domain. In certain embodiments, the PBCH carries basic system information needed for the UE 104 to begin communicating with the NE 102. Additionally, the NE 102 transmits the system information block (SIB) type 1 (SIB1) to indicate the RACH resources. The UE 104 determines RACH occasion (RO) resources, e.g., via decoding the SIB1. The MIB and SIB1 together form the minimum system information.

After performing DL synchronization and acquiring essential SI, such as the MIB and the SIB1, the UE 104 performs UL synchronization and resource request by performing a random-access procedure, referred to as “RACH procedure” by selecting and transmitting a preamble on the physical random access channel (PRACH). The PRACH preamble (also referred to as a “RACH preamble”) is transmitted during an RO, i.e., a predetermined set of time-frequency resources that are available for the reception of the PRACH preamble. The PRACH preamble is a specially designed signal that allows the NE 102 to detect the UE 104's presence and measure its timing offset. Each preamble serves as a temporary identifier for the access attempt, permitting the NE 102 to estimate the UE 104's UL propagation delay and assign an appropriate timing advance. Note that with beam-based communication, the UE 104 may select a certain DL beam and transmit the PRACH preamble on a corresponding UL beam. In such embodiments, there may be a mapping between SSB and RACH occasion, allowing the network to determine which beam the UE 104 has selected.

Regarding random access, two types of RACH procedure are supported in a Third Generation Partnership Project (3GPP) wireless communication network: A) a 4-step random-access (RA) type initiated by the sending of a RACH message 1 (Msg1) and 2-step RA type with RACH message A (MsgA). Both types of RACH procedure support contention-based random access (CBRA) and contention-free random access (CFRA).

The UE 104 selects the RA type at the initiation of the RACH procedure, e.g., based on network configuration. In one example, when CFRA resources are not configured, a RSRP threshold is used by the UE 104 to select between 2-step RA type and 4-step RA type. In another example, when CFRA resources for 4-step RA type are configured, the UE 104 performs random access with 4-step RA type. In another example, when CFRA resources for 2-step RA type are configured, the UE 104 performs random access with 2-step RA type.

Note that the network does not configure CFRA resources for 4-step and 2-step RA types at the same time for a bandwidth part (BWP). Additionally, the CFRA with 2-step RA type is only supported for handover. Note that a BWP refers to a particular subset of the overall channel bandwidth within a carrier, allowing for flexible and efficient use of the frequency resources within the carrier. For example, the NE 102 may dynamically enable a respective BWP based on user demand and/or network conditions. In some examples, the BWP may consist of at least one DL BWP and at least one UL BWP.

The Msg1 of the 4-step RA type consists of a preamble transmitted on a PRACH. After the Msg1 transmission, the UE 104 monitors for a response (i.e., a RAR message) from the network within a configured window, known as the RAR window. For CFRA, a dedicated preamble for Msg1 transmission is assigned by the network and upon receiving the RAR message from the network, the UE 104 ends the random access procedure. In certain implementations, failure to receive the RAR triggers re-transmission of PRACH preambles by the UE 104. For CBRA, upon reception of the RAR, the UE 104 sends a RACH message 3 (Msg3) a PUSCH transmission, i.e., using a UL grant scheduled in the RAR, and monitors for contention resolution. If contention resolution is not successful after Msg3 (re)transmission(s), then the UE 104 goes back to Msg1 transmission.

The MsgA of the 2-step RA type includes a preamble on the PRACH and a payload on the PUSCH. After the MsgA transmission, the UE 104 monitors for a response from the network within a configured window. For CFRA, a dedicated preamble and PUSCH resource are configured for MsgA transmission and upon receiving the network response, the UE 104 ends the random access procedure. For CBRA, if contention resolution is successful upon receiving the network response, then the UE 104 ends the random access procedure; however, if a fallback indication is received in a RACH message B (MsgB), the UE 104 performs Msg3 transmission using the UL grant scheduled in the fallback indication and monitors for contention resolution. If contention resolution is not successful after Msg3 (re)transmission(s), the UE 104 goes back to MsgA transmission.

If the random access procedure with 2-step RA type is not completed after a number of MsgA transmissions, the UE 104 can be configured to switch to CBRA with 4-step RA type.

In 5G, the RAR medium access control (MAC) PDU structure contains one or more MAC sub-PDUs and—optionally—padding. Each RO may have multiple preamble transmissions, and one MAC RAR PDU may contain up to 64 sub-PDUs. As such, the 5G RAR MAC PDU is a combined report acknowledging multiple Msg1 preamble transmissions.

In some implementations, each MAC sub-PDU may include A) 8 bytes containing a random access preamble identifier (RAPID) of a correspondingly received Msg1 (thereby acknowledging the reception of Msg1), and B) a 27 bit UL grant field, indicating a time-frequency resource for the corresponding Msg3 transmission.

Table 1 depicts an example of the contents and description of the UL grant for Msg3 containing 27 bits, shown below.

TABLE 1
RAR Grant Content Field Size

| RAR Grant Field | Number of Bits |
|---|---|
| Frequency hopping flag | 1 |
| PUSCH frequency | 12, for operation with shared spectrum channel |
| resource allocation | access in FR1 or for FR2-2 when parameter |
| | ChannelAccessMode2-r17 is provided, |
| | 14, otherwise |
| PUSCH time resource | 4 |
| allocation | |
| Modulation and coding | 4 |
| scheme (MCS) | |
| Transmit power control | 3 |
| (TPC) command | |
| for PUSCH | |
| Channel state | 1 |
| information | |
| (CSI) request | |
| ChannelAccess-CPext | 2, for operation with shared spectrum channel |
| | access in FR1 or for FR2-2 when parameter |
| | ChannelAccessMode2-r17 is provided, |
| | 0, otherwise |

Because the coverage enhancements for Msg3 were introduced after 5G NR was initially defined, and because there are no reserved bits to transmit the information related to number of repetitions, the least significant bits (LSBs) are used in 5G NR Release-17 (Rel-17) to indicate the number of repetitions, i.e., meaning in 5G the MCS and the number of repetitions are jointly indicated to UE for Msg3 transmissions.

As described above, the RAR MAC PDU includes one or more MAC sub-PDUs and optionally padding. In 5G NR, each MAC sub-PDU consists of one of the following: A) a MAC subheader with backoff indicator (BI) only; B) a MAC subheader with RAPID only (i.e., acknowledgment for SI request); or C) a MAC subheader with RAPID and MAC RAR.

In some implementations, a MAC sub-PDU with BI-only is placed at the beginning of the MAC PDU, if included. In contrast, a MAC sub-PDU with RAPID only or a MAC sub-PDU with RAPID and MAC RAR can be placed anywhere between MAC sub-PDU with BI-only (if any) and padding (if any). Padding is placed at the end of the MAC PDU, if present. The presence and length of padding is implicit based on the TB size, and size of MAC sub-PDU(s).

A MAC subheader with BI consists of one octet with five header fields {E/T/R/R/BI}. A MAC subheader with RAPID consists of three header fields {E/T/RAPID}. The MAC subheader is octet aligned and consists of the following fields:

E: The Extension field is a flag indicating if the MAC sub-PDU including this MAC subheader is the last MAC sub-PDU or not in the MAC PDU. The E field is set to 1 to indicate at least another MAC sub-PDU follows. The E field is set to 0 to indicate that the MAC sub-PDU including this MAC subheader is the last MAC sub-PDU in the MAC PDU.

T: The Type field is a flag indicating whether the MAC subheader contains a RAPID or a BI. For example, the T field may be set to 0 to indicate the presence of a BI field in the subheader. As another example, the T field may be set to 1 to indicate the presence of a RAPID field in the subheader.

R: Reserved bit, set to 0. Only MAC subheader with BI contains any reserved bits.

BI: The BI field identifies the overload condition in the cell. The size of the BI field is 4 bits.

RAPID: The RAPID field identifies the transmitted RACH preamble. The size of the RAPID field is 6 bits. If the RAPID in the MAC subheader of a MAC sub-PDU corresponds to one of the RACH preambles configured for SI request, then MAC RAR is not included in the MAC sub-PDU.

Regarding the payload of a RAR MAC PDU, the RAR is of fixed size and is octet aligned. The MAC RAR consists of the following fields:

One reserved bit, set to 0.

Timing advance command: this field indicates the index value timing advance (TA) used to control the amount of timing adjustment that the UE MAC entity is to apply. The size of the timing advance command field is 12 bits.

UL Grant: this field indicates the time-frequency resources to be used on the uplink. The size of the UL Grant field is 27 bits.

Temporary cell radio network temporary identifier (C-RNTI): this field indicates the temporary identity that is used by the UE MAC entity during the random access procedure. The size of the temporary C-RNTI field is 16 bits.

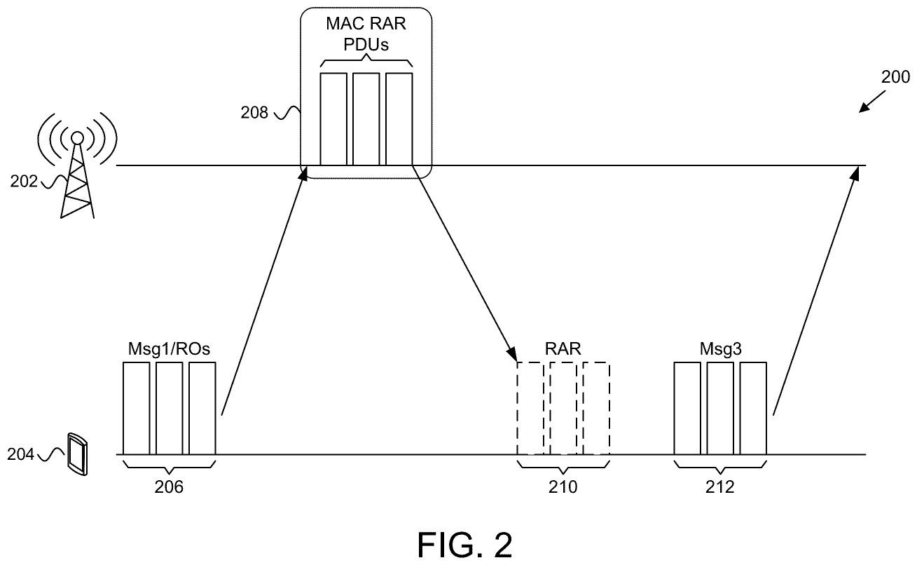

FIG. 2 illustrates an example of a RACH procedure 200 supporting multiple ROs, in accordance with aspects of the present disclosure. The procedure 200 may implement or be implemented by aspects of the wireless communication system 100. For example, the procedure 200 may include a gNB 202 and at least one UE 204. The gNB 202 may implement or be implemented by an NE 102, and the UE(s) 204 may implement or be implemented by one or more UEs 104 as described herein.

The UE(s) 204 receive a RACH configuration message indicating at least one of the multiple, clustered ROs 206 allocated in the RAN. Each UE 204 that needs to establish initial access selects an RO based on the RACH configuration message and determines the PRACH preamble for initiating the RACH procedure. As indicated above, certain PRACH preambles may be dedicated for specific uses, such as to request SI. Accordingly, the UE(s) 204 transmit their respective PRACH preambles during the selected ROs. As noted above, each RO may have multiple preamble transmissions. In certain implementations, a limited bandwidth UE or a UE requiring enhanced coverage may transmit duplicate copies of the PRACH preamble, as described in further detail below.

The gNB 202 monitors the configured ROs 206 and, upon receiving the one or more PRACH preambles, generates one or more RAR messages (e.g., one or more RAR MAC PDUs 208). The clustered ROs 206 (and corresponding Msg1 transmissions) means that multiple RAR MAC PDUs 208 may need to be transmitted successively for each RO. In some implementations, multiple RAR MAC sub-PDUs may be concatenated to minimize the payload of the RAR MAC PDU, thus the NE 102 may transmit a combined RAR message for multiple ROs. As noted above, one MAC RAR PDU may contain up to 64 sub-PDUs, where each sub-PDU may contain a RAPID followed by UL grant.

The UE(s) 204 monitor for the MAC RAR PDU(s) during the RAR window 210. Upon detecting a MAC RAR sub-PDU with a RAPID corresponding to its Msg1 transmission, a respective UE 204 determined the corresponding UL grant and prepares a Msg3 212 with a TB for transmission over the PUSCH. In some implementations, a UE 204 may transmit the Msg3-PUSCH 212 across multiple consecutive time slots using low code rate, as described in further detail below.

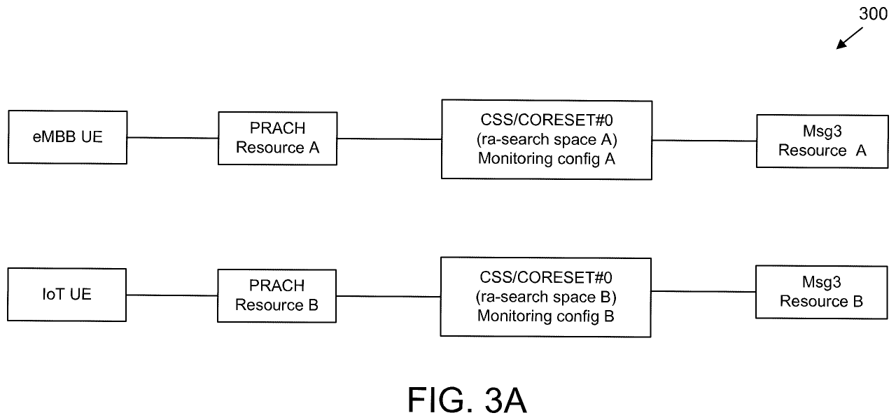

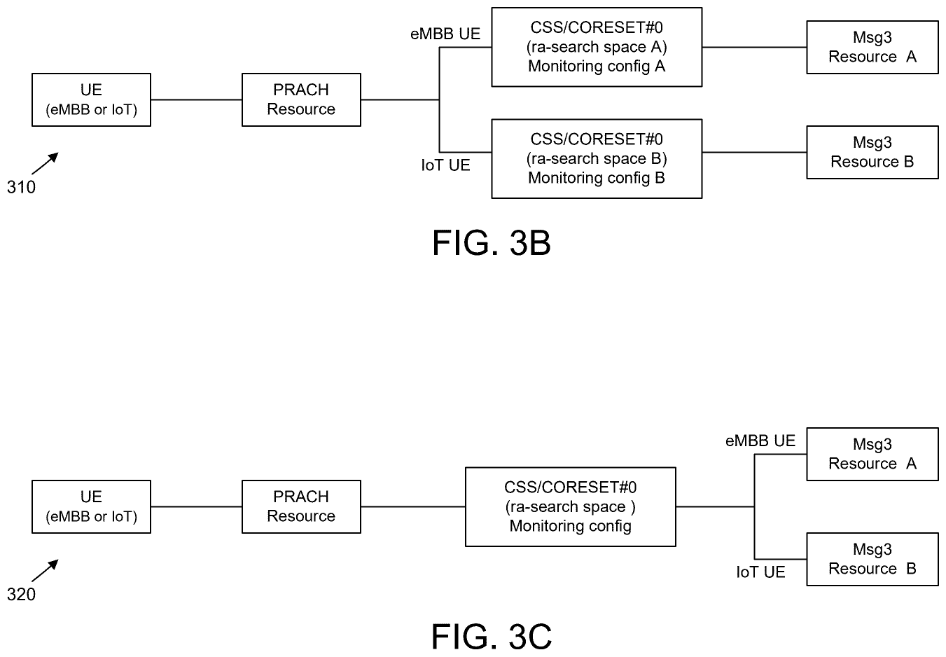

FIGS. 3A, 3B, and 3C depict examples of RACH resources for different device types, in accordance with aspects of the present disclosure. The RACH resources include a pool of PRACH resources, a pool of random-access search spaces, and a pool of Msg3 resources. In some implementations, the PRACH resources may be indicated by the RACH configuration. In certain implementations, the RACH configuration does not define the downlink search space for the RAR message; however, the RAN may signal an RA monitoring configuration that defines the downlink search space for the RAR message. In some implementations, the Msg3 resources may be indicated by the RAR message.

FIG. 3A depicts a first example of RACH resource allocations 300 for enhanced mobile broadband (eMBB) UEs and IoT UEs, in accordance with aspects of the present disclosure. The eMBB UEs and IoT UEs may implement or be implemented by one or more UEs 104 as described herein. Here, the IoT UEs may be bandwidth limited UEs requiring narrowband transmission of the PRACH preamble and/or the Msg3, e.g., using bandwidths of 180 kHz or less on low-band frequencies (i.e., under 1 GHz). In contrast, the eMBB UEs support wideband operation to provide higher data rates, e.g., using bandwidths up to 100 MHz in FR1 and up to 400 MHz in millimeter-wave frequencies (e.g., FR2).

In the depicted embodiment, a first set of the cell's PRACH resources (denoted “PRACH Resource A”) is dedicated for use by the eMBB UEs, while a second set of the cell's PRACH resources (denoted “PRACH Resource B”) is dedicated for use by the IoT UEs.

Upon decoding the MIB and SIB1 (i.e., the minimum system information), the UEs (eMBB and IoT) discover the time-frequency location of the default control resource set (CORESET #0) linked to the common search space (CSS) and when to monitor it for RAR messages. In the depicted embodiment, a first set of search spaces for RAR (denoted “ra-search space A”) may be dedicated for use by the eMBB UEs, while a second set of search spaces for RAR (denoted “ra-search space B”) may be dedicated for use by the IoT UEs. In some implementations, the RAN configures the eMBB UEs with a first RA monitoring configuration (denoted “Monitoring Config A”) indicating the ra-search space A, and configures the IoT UEs with a second RA monitoring configuration (denoted “Monitoring Config B”) indicating the ra-search space B.

Upon receiving and decoding the RAR, the eMBB UEs may receive an UL grant within a first A″) may be dedicated for use by the eMBB UEs, while a second set of PUSCH resources for Msg3-PUSCH transmission (denoted “Msg3 Resource B”) may be dedicated for use by the IoT UEs.

FIG. 3B depicts a second example of RACH resource allocations 310 for eMBB UEs and IoT UEs, in accordance with aspects of the present disclosure. The eMBB UEs and IoT UEs may implement or be implemented by one or more UEs 104 as described herein. Again, the IoT UEs may be bandwidth limited UEs requiring narrowband transmission of the PRACH preamble and/or the Msg3.

As illustrated in FIG. 3B, a common set of PRACH resources may be used by the eMBB UEs and the IoT UEs. However, a first set of search spaces for RAR (denoted “ra-search space A”) may be dedicated for use by the eMBB UEs, while a second set of search spaces for RAR (denoted “ra-search space B”) may be dedicated for use by the IoT UEs. In some implementations, the RAN configures the eMBB UEs with a first RA monitoring configuration (denoted “Monitoring Config A”) indicating the ra-search space A, and configures the IoT UEs with a second RA monitoring configuration (denoted “Monitoring Config B”) indicating the ra-search space B.

Upon receiving and decoding the RAR, the eMBB UEs may receive an UL grant within a first A″) may be dedicated for use by the eMBB UEs, while a second set of PUSCH resources for Msg3-PUSCH transmission (denoted “Msg3 Resource B”) may be dedicated for use by the IoT UEs.

FIG. 3C depicts a third example of RACH resource allocations 320 for eMBB UEs and IoT UEs, in accordance with aspects of the present disclosure. The eMBB UEs and IoT UEs may implement or be implemented by one or more UEs 104 as described herein. Again, the IoT UEs may be bandwidth limited UEs requiring narrowband transmission of the PRACH preamble and/or the Msg3.

As illustrated in FIG. 3C, a common set of PRACH resources may be used by the eMBB UEs and the IoT UEs, and a common set of search spaces for RAR (denoted “ra-search space”) may be dedicated for use by the eMBB UEs and the IoT UEs for receiving the RAR message.

However, upon receiving and decoding the RAR, the eMBB UEs may receive an UL grant within a first A″) may be dedicated for use by the eMBB UEs, while a second set of PUSCH resources for Msg3-PUSCH transmission (denoted “Msg3 Resource B”) may be dedicated for use by the IoT UEs.

To support bandwidth limited and extended coverage devices, RACH transmissions (e.g., Msg1, Msg3, MsgA, etc.) may be configured for longer transmission duration according to the coverage type, device type, or a combination thereof. In some implementations, the network may configure a plurality of PRACH preamble formats by conveying a plurality of RACH configuration indices, whereby a UE selects a preamble format according to its coverage type, device type, or a combination thereof. Similarly, the network may indicate support for slot bundling of Msg3 according to the coverage type, device type, or a combination thereof.

In some embodiments, coverage improvements using narrowband Msg1 and Msg3 transmission for bandwidth limited and extended coverage devices may be achieved by using longer preamble format for Msg1 with fewer physical resource blocks (PRBs) and slot bundling technique for Msg3 or MsgA PUSCH transmissions.

According to aspects of a first solution, a bandwidth limited and/or extended coverage UE 104 may be configured to use a longer RACH preamble format. In some implementations, the NE 102 may configure a plurality of parameter sets in the RACH configuration, where each parameter set may be associated with UEs 104 in different coverage or device types. In some implementations, the NE 102 may configure the plurality of parameter sets in the minimum system information. In other implementations, the NE 102 may configure the plurality of parameter sets via RRC signaling.

The RACH configuration specifies the PRACH resources and related parameters such as the time/frequency locations of ROs, RO periodicity, any association between PRACH resources and serving beams (e.g., for beam-based communication), preamble format (numerology, subcarrier spacing, symbol length), the number of preambles, preamble repetition parameters, power ramping configuration, and timing offsets relative to downlink synchronization signals.

In some implementations, the RACH configuration includes a plurality of RACH configuration indices and a set of thresholds. Each RACH configuration index corresponds to one of the plurality of parameter sets, e.g., containing the RACH preamble format and associated RO parameters, including periodicity, the starting symbol, the number of PRACH slots in a subframe, the number of time domain occasions in a PRACH slots, the PRACH duration, etc. In some implementations, the RACH configuration includes information for slot bundling and associated code rate for Msg3 PUSCH transmission occasions, as described in greater detail below.

In one implementation, RACH configuration indices containing a different preamble format(s) may be associated with a separate RACH occasion(s). In another implementation, one or more RACH configuration index having same preamble format may be multiplexed and mapped to the same RACH occasion.

In some implementations, the NE 102 may configure different sets of orthogonal preambles associated with each of these RACH configuration index, RACH preamble format, or a combination thereof. Such orthogonal preambles may be generated by assigning one or more root sequences to each of these configuration index, preamble format or a combination thereof.

In some examples, these root sequences for FR1 bands may be Zadoff Chu (ZC) sequences, known for their constant amplitude and zero autocorrelation properties. For example, a single root sequence can produce multiple distinct, orthogonal preambles through the application of cyclic shifts, each orthogonal preamble corresponding to a unique preamble index. This approach allows a single root sequence to support multiple UEs 104 within the same cell while minimizing cross-correlation and interference among different preambles.

In other examples, the root sequences for millimeter-wave frequencies (e.g., FR2 bands), non-ZC sequences may be used to improve performance under large bandwidths and high delay spreads common to millimeter-wave frequencies.

The use of these mathematically structured root sequences allows for precise timing estimation and robust detection under challenging radio conditions. Furthermore, the cyclic-shifted structure of the preambles also provides scalability, enabling the NE 102 to configure a desired number of unique preambles by selecting one or more root sequences and their associated shifts.

In another implementation, the NE 102 may configure one or more RACH configuration index or may dynamically activate one or more RACH configuration index from a list containing plurality of configuration indices. For example, the NE 102 may dynamically signal in a MAC control element (CE) or in group-common downlink control information (DCI) to activate (or deactivate) certain RACH configuration indices, ROs and associated muting pattern, or a combination thereof.

In some implementations, the selection of a RACH configuration index at a UE 104 may be based on the set of thresholds provided in the configuration for RACH transmission. In certain implementations, the thresholds can be semi-statically configured in the minimum system information. The set of thresholds may relate to measured signal strength or signal quality. While the following descriptions describe the threshold with respect to the RSRP, in other implementations the thresholds may relate to other (or multiple) measured signal qualities, including—but not limited to—the received signal strength indicator (RSSI),/signal-to-noise ratio (SNR), signal-to-interference-plus-noise ratio (SINR), reference signal received quality (RSRQ), channel quality indicator (CQI), and the like.

In certain implementations, the NE 102 may semi-statically configure a first set of RSRP-based thresholds, e.g., measured based on the DL synchronization signal (e.g., PSS and/or SSS) or a pathloss reference signal. For example, the first set of RSRP-based thresholds may be semi-statically configured in the minimum system information. In such implementations, the first set of RSRP-based thresholds may be associated with the selection of RACH configuration indices associated with different preamble formats.

In some implementations, the RSRP measurements and RSRP-based thresholds may additionally take into account an offset configured due to the UE power class (e.g., considering the maximum UL transmit power), the number of Tx/Rx antennas, the cubic metric differences due to the discrete Fourier transform-spread OFDM (DFT-s-OFDM) or cyclic prefix OFDM (CP-OFDM) waveforms, or a combination thereof due to diverse device types.

In various embodiments, those UEs 104 in the good coverage (e.g., with RSRP above the configured threshold) may select a RACH configuration index associated with a shorter preamble format (i.e., one slot or less), while those UEs 104 in the bad coverage (e.g., with RSRP below the configured threshold) may select a RACH configuration index associated with a longer preamble format (i.e., more than one slot, e.g., 2-3 slots).

In some implementations, the NE 102 may configure a second set of RSRP-based thresholds, e.g., measured based on the DL synchronization signal or a pathloss reference signal. For example, the second set of RSRP-based thresholds may be semi-statically configured in the minimum system information. In such implementations, the first set of RSRP-based thresholds may be associated with the repetition count of the preamble transmission.

In certain implementations, the NE 102 may configure a hierarchical combination of the first set of RSRP-based thresholds and the second sets of RSRP-based thresholds. In other words, in a first step, the UE 104 may first check whether it is above or below the first set of RSRP-based thresholds to determine the configuration index and/or preamble formats and, in the second step, the UE 104 may check whether it requires additional repetitions in the selected configuration index or format to meet the target RSRP threshold. In one implementation, the number of repetition counts associated with each of the second set of thresholds may be different depending on the selected preamble formats.

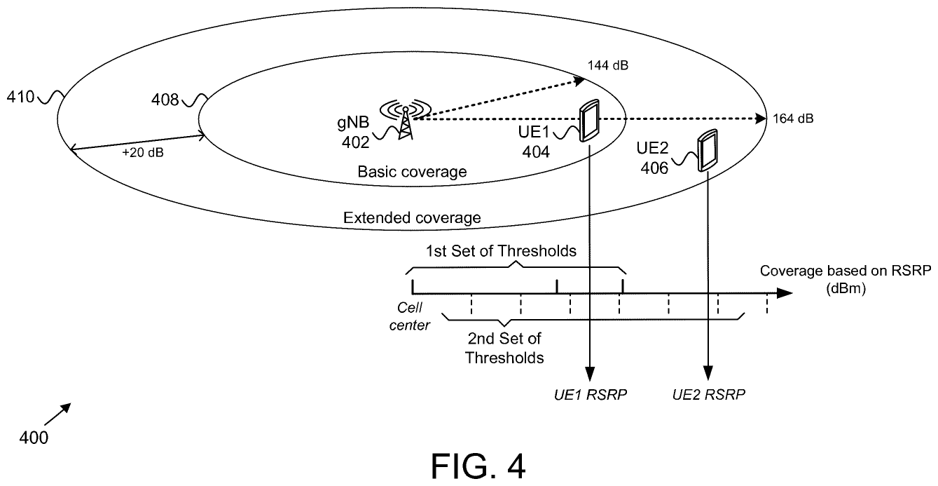

FIG. 4 illustrates an example of a system 400 for coverage based on RSRP, in accordance with aspects of the present disclosure. The system 400 may implement or be implemented by aspects of the wireless communication system 100. For example, the system 400 may include a gNB 402, a first UE 404 (denoted (“UE1”), and a second UE 406 (denoted “UE2”). The gNB 402 may implement or be implemented by an NE 102, and the first UE 404 and the second UE 406 may implement or be implemented by one or more UEs 104 as described herein.

The gNB 402 supports a cell with a basic coverage area 408 associated with a first power level (e.g., 144 dB) and an extended coverage area 410 associated with a second power (e.g., 164 dB). The gNB 402 transmits, e.g., in the minimum system information, a RACH configuration with a plurality of RACH configuration indices, a first set of RSRP-based thresholds, and a second set of RSRP-based thresholds. The UEs 404 and 406 select the RACH configuration index based on the RSRP measurements, e.g., of the PSS/SSS transmitted by the gNB 402.

In some examples, the first UE 404 measures the RSRP of the PSS/SSS and determines that it is in good coverage, e.g., within the basic coverage area 408. Accordingly, the first UE 404 selects the RACH preamble format based on the measured RSRP and the first set of RSRP-based thresholds. Here, it is assumed that the first UE 404 selects a RACH configuration index associated with a shorter preamble format (i.e., one PRACH slot or less) due to being in good coverage, e.g., within the basic coverage area 408. Moreover, based on the measured RSRP and the second set of RSRP-based thresholds, the first UE 404 may select a number of preamble repetition to meet the target RSRP threshold with the selected shorter preamble format. In some examples, due to being near the edge of the basic coverage area 408, the first UE 404 may select a number of preamble repetitions greater than one.

In some other examples, the second UE 406 measures the RSRP of the PSS/SSS and determines that it is in poor coverage, e.g., within the extended coverage area 410. Accordingly, the second UE 406 selects the RACH preamble format based on the measured RSRP and the first set of RSRP-based thresholds. Here, it is assumed that the second UE 406 selects a RACH configuration index associated with a longer preamble format (i.e., more than one PRACH slot) due to being in poor coverage, e.g., within the extended coverage area 410. Moreover, based on the measured RSRP and the second set of RSRP-based thresholds, the second UE 406 may select a number of preamble repetition to meet the target RSRP threshold with the selected longer preamble format. In some examples, due to being near the edge of the extended coverage area 410, the second UE 406 may select a number of preamble repetitions greater than one.

In some implementations, there may be two types of RACH sequence lengths, referred to as a long RACH sequence and a short RACH sequence associated with the long PRACH format(s) and short PRACH format(s), respectively.

In certain implementations, the long sequence may support or more long RACH formats using long sequence of preambles, for example, of length 839. In some examples, the long sequence may mainly target large cell deployment scenarios, as the longer preamble duration allows larger cell coverage.

In certain implementations, the short sequence may support one or more short RACH formats using short sequence of preambles, for example, of length 139 or ¼ or less the length of a long preamble. In some examples, the short sequence may mainly target small/normal cell and indoor deployment scenarios and supports lower latency than the long sequence.

In one implementation, the long and short PRACH formats can be configured with different SCS. For example, the long RACH formats may be associated with smaller SCS values, e.g., 1.25 kHz or 5 kHz, while the short RACH formats may be associated with larger SCS values, e.g., 15×2″ kHz, where μ=0, 1, 2, etc. (hence 15 kHz, 30 kHz, 60 kHz, etc.). Accordingly, the UEs 404 and 406 may need to switch SCS when selecting the corresponding RACH formats according to the first set of RSRP-based threshold as described above.

In another implementation, the RAR window duration indicated by the minimum system information may be differently configured corresponding to a short RACH format or a long RACH format. For example, a longer RAR window may be associated with the longer preamble formats.

According to aspects of a second solution, a bandwidth limited and/or extended coverage UE 104 may be configured with a longer transmission duration for RACH-based PUSCH transmission, e.g., RACH Msg3 or RACH MsgA. In certain implementations, the NE 102 may support slot bundling, meaning TB processing over multi-slot (TBoMS), wherein a UE 104 transmits a single TB across multiple consecutive time slots. Accordingly, for bandwidth limited and/or extended coverage UEs 104, the slot bundling may be used for the transmission of Msg3-PUSCH (e.g., for 4-step RACH procedures) or MsgA-PUSCH (e.g., for 2-step RACH procedures) using a low code rate.

In some implementations, UEs 104 in poor coverage (i.e., with RSRP measurements below a threshold) may use low code rate for Msg3-PUSCH or MsgA-PUSCH transmission using slot bundling techniques (e.g., TBoMS). In some implementations, UEs 104 with limited resource block (RB) allocation (i.e., narrowband transmission) may use low code rate for Msg3-PUSCH or MsgA-PUSCH transmission using slot bundling techniques (e.g., TBoMS). In one implementation, such narrowband Msg3 PUSCH transmission may be associated with a bandwidth limited UE device type. In another implementation, the narrowband Msg3 PUSCH transmission may be associated with an eMBB UE device type in the poor coverage area and/or requiring extended coverage.

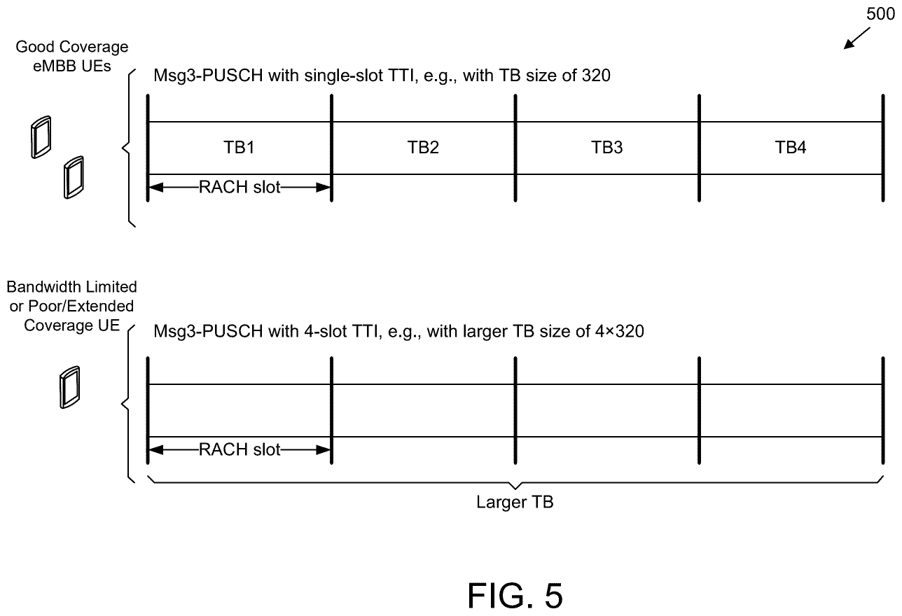

FIG. 5 illustrates a transmission scheme 500 for slot bundling a larger TB, in accordance with aspects of the present disclosure. The transmission scheme 500 may implement or be implemented by aspects of the wireless communication system 100. For example, the transmission scheme 500 may include transmissions by a set of eMBB UEs 502 in good coverage, and a transmission by a UE 504 that is bandwidth limited, in poor coverage, or requiring extended coverage. The eMBB UEs 502 and the UE 504 may implement or be implemented by one or more UEs 104 as described herein.

With TBoMS, the UE 504 may transmit the Msg3-PUSCH (i.e., comprising the larger TB) over 4 RACH slots. Here it is assumed that each single-slot transmit time interval (TTI) supports a maximum TB size of 320 bytes. Accordingly, Msg3-PUSCH transmissions by the set of eMBB UEs 502 in good coverage may comprise multiple TBs for Msg3-PUSCH, each TB transmitted within a single RACH slot and having a maximum TB size of 320 bytes.

In contrast, the larger TB has a TB size of 1280 bytes (i.e., 4×320 bytes) and spans 4 RACH slots in duration. The larger TB size of the TBoMS transmission may be due to lower code rate, a greater number of redundancy bits, or other encoding techniques to improve the reliability of reception by a NE 102.

In some implementations, a NE 102 may explicitly or implicitly convey an indication for slot bundling (e.g., a TBoMS signaling indication). In one implementation, MAC subheader for RAR containing the UL grant for the Msg3 may expressly indicate the usage of TBoMS for the Msg3 PUSCH transmission. In another implementation, the NE 102 may implicitly indicate the usage of TBoMS by the UL DCI format for RAR. For example, a DCI format 0-1 scrambled with the temporary C-RNTI may implicitly signal the usage of TBoMS for the Msg3 PUSCH transmission. In another implementation, the time domain and frequency domain resource allocation may indicate the usage of TBoMS. For example, the NE 102 may implicitly indicate the usage of TBoMS by indicating a number of time domain symbols greater than the slot length, e.g., of 14 OFDM symbols.

In certain implementations, there may be an association between the selection of the longer preamble format for Msg1 and the TBoMS indication for the Msg3-PUSCH or MsgA-PUSCH transmission. For example, if the comparison of the measured PSS/SSS (or pathloss reference signal) to the first set of thresholds indicates that the longer preamble format is to be used, then the UE 104 may also use TBoMS for the Msg3-PUSCH or MsgA-PUSCH transmission. As another example, TBoMS may be unavailable for the Msg3-PUSCH or MsgA-PUSCH transmission if the shorter preamble format is to be used.

In one embodiment, the RACH configuration may include a third set of RSRP-based thresholds for selecting the level of TBoMS to use for the Msg3-PUSCH or MsgA-PUSCH transmission. In another embodiment, the first set of thresholds may jointly indicate the preamble format is to be used and the level of TBoMS to use (e.g., none, TBoMS over a 2-slot TTI, TBoMS over a 3-slot TTI, TBoMS over a 4-slot TTI, etc.). In other implementations, the selection of the longer preamble format for Msg1 may be independent of TBoMS for the Msg3-PUSCH or MsgA-PUSCH transmission.

In some implementations, the NE 102 may semi-statically configure the demodulation reference signal (DMRS) pattern to be using TBoMS benefiting the joint channel estimation. For example, with TBoMS the channel estimation may be performed over the entire TB (e.g., over multiple slots). Accordingly, the NE 102 may configure the DMRS pattern for TBoMS, e.g., in the minimum system information or using RRC signaling.

In some implementations, for the case of TBoMS, the UE 104 may begin the contention resolution timer after the transmission of last transport block or transmission of a single transport block in the last slot, as the TBoMS can be associated with a single transport block in multi-slot transmission. Further, the UE 104 may stop the timer when the Msg4 (or MsgB) is received.

In some implementations, a TBoMS transmission may be transmitted in consecutive UL slots or transmitted in sub-band duplex slots, wherein both DL and UL can be performed in the sub-band duplex slots in different frequency regions. Further, the transmission may be transmitted in a combination of UL and sub-band duplex slots.

As noted above, the RAR grant field may include a frequency hopping flag to indicate that frequency hopping is to be applied to the Msg3-PUSCH. In some implementations, the frequency hopping may be configured in combination with TBoMS.

In some implementations, Msg3 transmission may be enhanced by the NE 102 configuring the UE 104 with PUSCH repetition in addition to the usage of TBoMS, and each repetition may be performed using a configured redundancy version, e.g., to improve the coding gain. In such implementations, the NE 102 may configure the redundancy version sequence (e.g., [0, 2, 3, 1], [1, 1, 1, 1]) in the RAR, or in the UL DCI format for RAR, or via higher-layer signaling (e.g., RRC signaling, MAC CE), or in the minimum system information.

In some implementations, a Msg3 transmission may be enhanced by segmenting the Msg3 into two or more transport blocks or code block segments (or a combination thereof) for transmission. In such implementations, the segmentation may be applicable in poor coverage areas, e.g., in combination with a low coding rate applied to each transport block. In one implementation, a MAC sub-PDU containing the RAR may implicitly indicate the presence of segmentation (i.e., whether Msg3 segmentation is enabled or not), e.g., in relation to the MCS. Alternatively, the RAR may explicitly indicate whether Msg3 segmentation is enabled.

According to the aspects of a third solution, a UE 104 (including—but not limited to—a bandwidth limited and/or extended coverage UE 104) may be configured to determine a waveform for RACH procedure communications. In some implementations, the synchronization frequency rasters may be differently configured to indicate the type of waveform. For example, the type of waveform used for the initial access may be DFT-s-OFDM or one of its variants, such as sub-band DFT-s-OFDM or CP-OFDM. As used herein, a synchronization signal raster refers to a specific, standardized set of frequency points at which the NE 104 transmits its SSB. The synchronization signal raster provides the UE 104 with information on what frequencies to monitor when performing the initial cell search.

In some embodiments, a UE 104 may detect a synchronization signal in first synchronization raster, wherein first synchronization raster may be reserved for the transmission of a synchronization signal (e.g., PSS and/or SSS) using a first type of waveform. The UE 104 may implicitly detect the first type of waveform to receive the synchronization signal from the first synchronization raster. Similarly, the UE 104 may detect a synchronization signal in the second synchronization frequency raster wherein the second synchronization raster may indicate the second type of waveform (i.e., different than the first type) for the transmission of the synchronization signal.

Using such methodology, a UE 104 may avoid blind detection of the type of waveform used for the reception of synchronization signal by simply correlating the type of waveform used for the synchronization signal transmission to one or more synchronization frequency rasters. Accordingly, once the UE 104 detects the waveform of the synchronization signal, the UE 104 may assume that same waveform may be used for the reception of PBCH and/or for RACH communications (i.e., referring to the transmission of the Msg1 preamble, for the reception of Msg2 (i.e., RAR), for the transmission of the Msg3, transmission of the MsgA (i.e., preamble+PUSCH) and/or reception of the MsgB). In certain embodiments, the minimum system information may include an indication that the waveform of the synchronization signal is to be used for RACH communications (or some subset thereof).

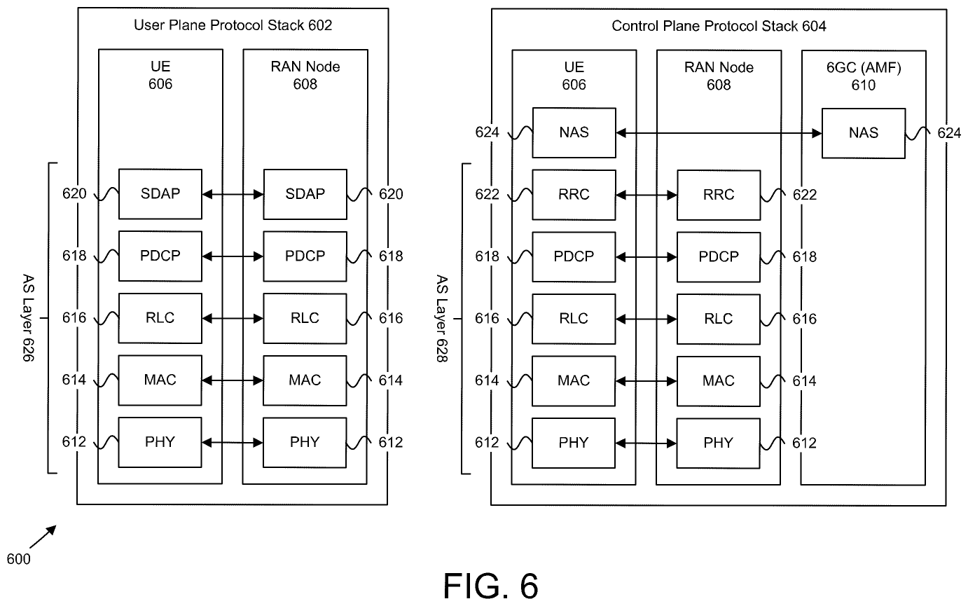

FIG. 6 illustrates an example of a protocol stack 600, in accordance with aspects of the present disclosure. While FIG. 6 shows a UE 606, a RAN node 608, and a 5GC 610 (e.g., comprising at least an AMF), these are representative of a set of UEs 104 interacting with an NE 102 (e.g., base station) and a CN 106. As depicted, the protocol stack 600 comprises a user plane protocol stack 602 and a control plane protocol stack 604. The user plane protocol stack 602 includes a physical (PHY) layer 612, a MAC sublayer 614, a radio link control (RLC) sublayer 616, a packet data convergence protocol (PDCP) sublayer 618, and a service data adaptation protocol (SDAP) sublayer 620. The control plane protocol stack 604 includes a PHY layer 612, a MAC sublayer 614, an RLC sublayer 616, and a PDCP sublayer 618. The control plane protocol stack 604 also includes a RRC layer 622 and a non-access stratum (NAS) layer 624.

The AS layer 626 (also referred to as “AS protocol stack”) for the user plane protocol stack 602 consists of at least the SDAP sublayer 620, the PDCP sublayer 618, the RLC sublayer 616, the MAC sublayer 614, and the PHY layer 612. The AS layer 628 for the control plane protocol stack 604 consists of at least the RRC layer 622, the PDCP sublayer 618, the RLC sublayer 616, the MAC sublayer 614, and the PHY layer 612. The layer-1 (L1) includes the PHY layer 612. The layer-2 (L2) is split into the SDAP sublayer 620, PDCP sublayer 618, RLC sublayer 616, and MAC sublayer 614. The layer-3 (L3) includes the RRC layer 622 and the NAS layer 624 for the control plane and includes, e.g., an internet protocol (IP) layer and/or PDU layer (not depicted) for the user plane. L1 and L2 are referred to as “lower layers,” while L3 and above (e.g., transport layer, application layer) are referred to as “higher layers” or “upper layers.”

The PHY layer 612 offers transport channels to the MAC sublayer 614. The PHY layer 612 may perform a beam failure detection procedure using energy detection thresholds, as described herein. In certain embodiments, the PHY layer 612 may send an indication of beam failure to a MAC entity at the MAC sublayer 614. The MAC sublayer 614 offers logical channels (LCHs) to the RLC sublayer 616. The RLC sublayer 616 offers RLC channels to the PDCP sublayer 618.

The PDCP sublayer 618 offers radio bearers to the SDAP sublayer 620 and/or RRC layer 622. The SDAP sublayer 620 offers QoS flows to the core network (e.g., 5GC). The RRC layer 622 provides for the addition, modification, and release of carrier aggregation (CA) and/or dual connectivity. The RRC layer 622 also manages the establishment, configuration, maintenance, and release of signaling radio bearers (SRBs) and data radio bearers (DRBs).

The NAS layer 624 is between the UE 606 and an AMF in the 5GC 610. NAS messages are passed transparently through the RAN. The NAS layer 624 is used to manage the establishment of communication sessions and for maintaining continuous communications with the UE 606 as it moves between different cells of the RAN. In contrast, the AS layers 626 and 628 are between the UE 606 and the RAN (i.e., RAN node 608) and carry information over the wireless portion of the network. While not depicted in FIG. 6, the IP layer exists above the NAS layer 624, a transport layer exists above the IP layer, and an application layer exists above the transport layer.

The MAC sublayer 614 is the lowest sublayer in the L2 architecture of the NR protocol stack. Its connection to the PHY layer 612 below is through transport channels, and the connection to the RLC sublayer 616 above is through LCHs. The MAC sublayer 614 therefore performs multiplexing and demultiplexing between LCHs and transport channels: the MAC sublayer 614 in the transmitting side constructs MAC PDUs (also known as transport blocks (TBs)) from MAC service data units (SDUs) received through LCHs, and the MAC sublayer 614 in the receiving side recovers MAC SDUs from MAC PDUs received through transport channels.

The MAC sublayer 614 provides a data transfer service for the RLC sublayer 616 through LCHs, which are either control LCHs which carry control data (e.g., RRC signaling) or traffic LCHs which carry user plane data. On the other hand, the data from the MAC sublayer 614 is exchanged with the PHY layer 612 through transport channels, which are classified as UL or DL. Data is multiplexed into transport channels depending on how it is transmitted over the air.

The PHY layer 612 is responsible for the actual transmission of data and control information via the air interface, i.e., the PHY layer 612 carries all information from the MAC transport channels over the air interface on the transmission side. Some of the important functions performed by the PHY layer 612 include coding and modulation, link adaptation (e.g., adaptive modulation and coding (AMC)), power control, cell search and random access (for initial synchronization and handover purposes) and other measurements (inside the 3GPP system (i.e., NR and/or LTE system) and between systems) for the RRC layer 622. The PHY layer 612 performs transmissions based on transmission parameters, such as the modulation scheme, the coding rate (i.e., the MCS), the number of PRBs, etc.

In 5G NR, the resource block (RB) typically spans 12 subcarriers, and the bandwidth of the RB depends on the SCS used in the 5G NR system. For example, for 15 kHz SCS, the bandwidth of one RB is 180 kHz, while for 30 kHz SCS, the bandwidth of one RB is 360 kHz. Similarly, for 60 kHz SCS, the bandwidth of one RB is 720 kHz, while for 120 kHz SCS, the bandwidth of one RB is 1.44 MHz.

The duration of an RB in time is one slot, which may be composed of, e.g., 14 OFDM symbols in the time domain. In 5G NR, the time duration of an RB is based on the slot duration, which may vary according to the numerology and SCS used. For example, for 15 kHz SCS, the time duration of one RB (i.e., slot duration) is 1 ms, while for 30 kHz SCS, the time duration of one RB (slot duration) is 0.5 ms. Similarly, for 60 kHz SCS, the time duration of one RB (i.e., slot duration) is 0.25 ms, while for 120 kHz SCS, the time duration of one RB (slot duration) is 0.125 ms.

In some embodiments, the protocol stack 600 may be an NR protocol stack used in a 5G NR system. An LTE protocol stack comprises similar structure to the protocol stack 600, with the differences that the LTE protocol stack lacks the SDAP sublayer 620 in the AS layer 626, that an EPC replaces the 5GC 610, and that the NAS layer 624 is between the UE 606 and an MME in the EPC. Also, the present disclosure distinguishes between a protocol layer (such as the aforementioned PHY layer 612, MAC sublayer 614, RLC sublayer 616, PDCP sublayer 618, SDAP sublayer 620, RRC layer 622 and NAS layer 624) and a transmission layer in multiple-input multiple-output (MIMO) communication (also referred to as a “MIMO layer” or a “data stream”).

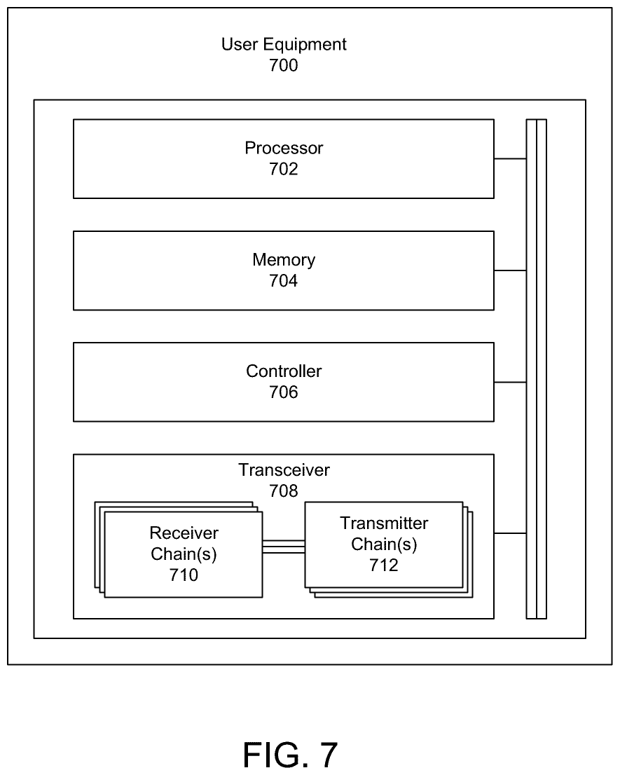

FIG. 7 illustrates an example of a UE 700 in accordance with aspects of the present disclosure. The UE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a central processing unit (CPU), an ASIC, a field programmable gate array (FPGA), or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the UE 700 to perform various functions of the present disclosure.

The memory 704 may include volatile or non-volatile memory. The memory 704 may store computer-readable, computer-executable code including instructions that, when executed by the processor 702, cause the UE 700 to perform various functions described herein. The code may be stored in a non-transitory computer-readable medium such the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the UE 700 to perform various functions (e.g., operations, signaling) described herein (e.g., executing, by the processor 702, instructions stored in the memory 704). In some implementations, the processor 702 may include multiple processors and the memory 704 may include multiple memories. One or more of the multiple processors may be coupled with one or more of the multiple memories, which may be individually or collectively, configured to perform various functions (e.g., operations, signaling) of the UE 700 as described herein.

The processor 702 coupled with the memory 704 may be configured to, capable of, or operable to cause the UE 700 to receive a configuration message for RACH transmission, the configuration message including a plurality of RACH configuration indices and a set of thresholds; select a first RACH configuration index based on a comparison of at least one reference signal measurement to the set of thresholds; and transmit, to a base station, a first RACH preamble having a preamble format based on the first RACH configuration index, where the preamble format includes a long preamble format for extended coverage or a short preamble for basic coverage.

In some implementations, each RACH configuration index corresponds to a set of RACH parameters, the RACH parameters including one or more of: A) a preamble format, B) a starting symbol, C) a number of PRACH slots in a subframe, D) a number of time domain occasions in the PRACH slots, E) a PRACH duration, or F) a combination thereof.

In some implementations, to receive the minimum system information, the processor 702 coupled with the memory 704 may be configured to, capable of, or operable to cause the UE 700 to receive a broadcast of minimum system information including the configuration message.

In certain implementations, the minimum system information includes a plurality of parameter sets, each parameter set associated with different coverage types or different device types.

In some implementations, the set of threshold includes at least a first set of RSRP based thresholds for selection of the preamble format and a second set of RSRP based threshold for selection of a number of repetition counts associated with transmission of the first RACH preamble. In certain implementations, the number of repetition counts associated with each threshold of the second set of thresholds is based on a selected preamble format.

In some implementations, the processor 702 coupled with the memory 704 may be configured to, capable of, or operable to cause the UE 700 to: A) determine a code rate for a PUSCH transmission associated with the first RACH preamble, and B) perform the PUSCH transmission over multiple slots using a slot bundling technique in response to the code rate satisfying a rate threshold.

In certain implementations, the processor 702 coupled with the memory 704 may be configured to, capable of, or operable to cause the UE 700 to determine the code rate based on the reference signal measurement.

In certain implementations, the processor 702 coupled with the memory 704 may be configured to, capable of, or operable to cause the UE 700 to: A) receive an indication of TBoMS, and B) perform the PUSCH transmission over multiple slots further based on the received indication. In such implementations, the PUSCH transmission includes a RACH Msg3 or a RACH MsgA.

In certain implementations, the processor 702 coupled with the memory 704 may be configured to, capable of, or operable to cause the UE 700 to initiate a contention resolution time in response to a transmission of a last transport block in a last slot associated with the PUSCH transmission.

The controller 706 may manage input and output signals for the UE 700. The controller 706 may also manage peripherals not integrated into the UE 700. In some implementations, the controller 706 may utilize an operating system (OS) such as iOS®, ANDROID®, WINDOWS®, or other operating systems. In some implementations, the controller 706 may be implemented as part of the processor 702.

In some implementations, the UE 700 may include at least one transceiver 708. In some other implementations, the UE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas for receiving the signal over the air or wireless medium. The receiver chain 710 may include at least one amplifier (e.g., a low-noise amplifier (LNA)) configured to amplify the received signal. The receiver chain 710 may include at least one demodulator configured to demodulate the received signal and obtain the transmitted data by reversing the modulation technique applied during transmission of the signal. The receiver chain 710 may include at least one decoder for decoding/processing the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

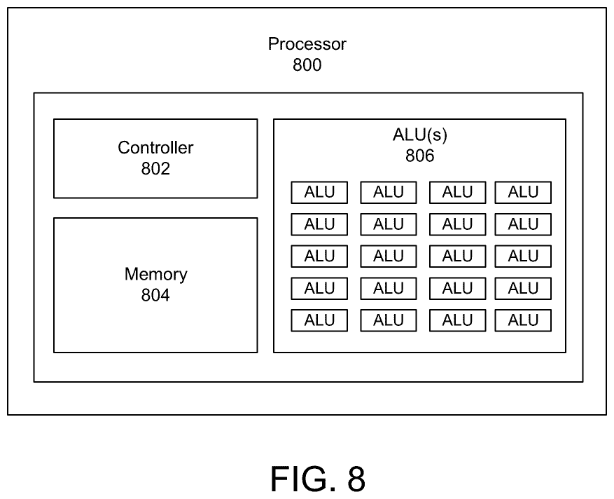

FIG. 8 illustrates an example of a processor 800 in accordance with aspects of the present disclosure. The processor 800 may be an example of a processor configured to perform various operations in accordance with examples as described herein. The processor 800 may include a controller 802 configured to perform various operations in accordance with examples as described herein. The processor 800 may optionally include at least one memory 804, which may be, for example, an L1, or L2, or L3 cache. Additionally, or alternatively, the processor 800 may optionally include one or more arithmetic-logic units (ALUs) 806. One or more of these components may be in electronic communication or otherwise coupled (e.g., operatively, communicatively, functionally, electronically, electrically) via one or more interfaces (e.g., buses).

The processor 800 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 800) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 802 may be configured to manage and coordinate various operations (e.g., signaling, receiving, obtaining, retrieving, transmitting, outputting, forwarding, storing, determining, identifying, accessing, writing, reading) of the processor 800 to cause the processor 800 to support various operations in accordance with examples as described herein. For example, the controller 802 may operate as a control unit of the processor 800, generating control signals that manage the operation of various components of the processor 800. These control signals include enabling or disabling functional units, selecting data paths, initiating memory access, and coordinating timing of operations.

The controller 802 may be configured to fetch (e.g., obtain, retrieve, receive) instructions from the memory 804 and determine subsequent instruction(s) to be executed to cause the processor 800 to support various operations in accordance with examples as described herein. The controller 802 may be configured to track memory address of instructions associated with the memory 804. The controller 802 may be configured to decode instructions to determine the operation to be performed and the operands involved. For example, the controller 802 may be configured to interpret the instruction and determine control signals to be output to other components of the processor 800 to cause the processor 800 to support various operations in accordance with examples as described herein. Additionally, or alternatively, the controller 802 may be configured to manage flow of data within the processor 800. The controller 802 may be configured to control transfer of data between registers, arithmetic logic units (ALUs), and other functional units of the processor 800.

The memory 804 may include one or more caches (e.g., memory local to or included in the processor 800 or other memory, such RAM, ROM, DRAM, SDRAM, SRAM, MRAM, flash memory, etc. In some implementations, the memory 804 may reside within or on a processor chipset (e.g., local to the processor 800). In some other implementations, the memory 804 may reside external to the processor chipset (e.g., remote to the processor 800).

The memory 804 may store computer-readable, computer-executable code including instructions that, when executed by the processor 800, cause the processor 800 to perform various functions described herein. The code may be stored in a non-transitory computer-readable medium such as system memory or another type of memory. The controller 802 and/or the processor 800 may be configured to execute computer-readable instructions stored in the memory 804 to cause the processor 800 to perform various functions. For example, the processor 800 and/or the controller 802 may be coupled with or to the memory 804, the processor 800, the controller 802, and the memory 804 may be configured to perform various functions described herein. In some examples, the processor 800 may include multiple processors and the memory 804 may include multiple memories. One or more of the multiple processors may be coupled with one or more of the multiple memories, which may, individually or collectively, be configured to perform various functions herein.

The one or more ALUs 806 may be configured to support various operations in accordance with examples as described herein. In some implementations, the one or more ALUs 806 may reside within or on a processor chipset (e.g., the processor 800). In some other implementations, the one or more ALUs 806 may reside external to the processor chipset (e.g., the processor 800). One or more ALUs 806 may perform one or more computations such as addition, subtraction, multiplication, and division on data. For example, one or more ALUs 806 may receive input operands and an operation code, which determines an operation to be executed. One or more ALUs 806 be configured with a variety of logical and arithmetic circuits, including adders, subtractors, shifters, and logic gates, to process and manipulate the data according to the operation. Additionally, or alternatively, the one or more ALUs 806 may support logical operations such as AND, OR, exclusive-OR (XOR), not-OR (NOR), and not-AND (NAND), enabling the one or more ALUs 806 to handle conditional operations, comparisons, and bitwise operations.

In some implementations, the processor 800 may support various functions (e.g., operations, signaling) of a UE, in accordance with examples as disclosed herein. For example, the controller 802 coupled with the memory 804 may be configured to, capable of, or operable to cause the processor 800 to receive a configuration message for RACH transmission, the configuration message including a plurality of RACH configuration indices and a set of thresholds; select a first RACH configuration index based on a comparison of at least one reference signal measurement to the set of thresholds; and transmit, to a base station, a first RACH preamble having a preamble format based on the first RACH configuration index, where the preamble format includes a long preamble format for extended coverage or a short preamble for basic coverage. Moreover, the controller 802 coupled with the memory 804 may be configured to, capable of, or operable to cause the processor 800 to perform one or more functions (e.g., operations, signaling) of the UE as described herein.

In certain implementations, the processor 800 may support various functions (e.g., operations, signaling) of a RAN node (e.g., base station or gNB), in accordance with examples as disclosed herein. For example, the controller 802 coupled with the memory 804 may be configured to, capable of, or operable to cause the processor 800 to transmit a configuration message for RACH transmission, the configuration message including a plurality of RACH configuration indices and a set of thresholds; transmit one or more reference signals; and receive, from a UE, a first RACH preamble having a preamble format associated with a first RACH configuration index and based on at least one reference signal measurement and the set of thresholds, where the preamble format includes a long preamble format for extended coverage or a short preamble for basic coverage. Moreover, the controller 802 coupled with the memory 804 may be configured to, capable of, or operable to cause the processor 800 to perform one or more functions (e.g., operations, signaling) of the RAN node as described herein.

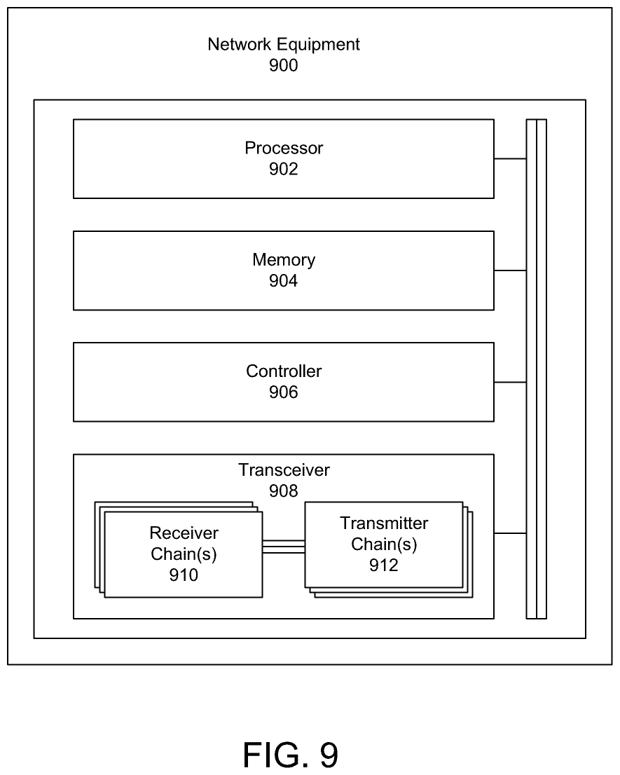

FIG. 9 illustrates an example of a NE 900 in accordance with aspects of the present disclosure. The NE 900 may include a processor 902, a memory 904, a controller 906, and a transceiver 908. The processor 902, the memory 904, the controller 906, or the transceiver 908, or various combinations thereof or various components thereof may be examples of means for performing various aspects of the present disclosure as described herein. These components may be coupled (e.g., operatively, communicatively, functionally, electronically, electrically) via one or more interfaces.

The processor 902, the memory 904, the controller 906, or the transceiver 908, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 902 may include an intelligent hardware device (e.g., a general-purpose processor, a DSP, a CPU, an ASIC, an FPGA, or any combination thereof). In some implementations, the processor 902 may be configured to operate the memory 904. In some other implementations, the memory 904 may be integrated into the processor 902. The processor 902 may be configured to execute computer-readable instructions stored in the memory 904 to cause the NE 900 to perform various functions of the present disclosure.

The memory 904 may include volatile or non-volatile memory. The memory 904 may store computer-readable, computer-executable code including instructions when executed by the processor 902 cause the NE 900 to perform various functions described herein. The code may be stored in a non-transitory computer-readable medium such the memory 904 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 902 and the memory 904 coupled with the processor 902 may be configured to cause the NE 900 to perform various functions (e.g., operations, signaling) described herein (e.g., executing, by the processor 902, instructions stored in the memory 904). In some implementations, the processor 902 may include multiple processors and the memory 904 may include multiple memories. One or more of the multiple processors may be coupled with one or more of the multiple memories, which may be individually or collectively, configured to perform various functions (e.g., operations, signaling) of the NE 900 as described herein.

The processor 902 coupled with the memory 904 may be configured to, capable of, or operable to cause the NE 900 to transmit a configuration message for RACH transmission, the configuration message including a plurality of RACH configuration indices and a set of thresholds; transmit one or more reference signals; and receive, from a UE, a first RACH preamble having a preamble format associated with a first RACH configuration index and based on at least one reference signal measurement and the set of thresholds, where the preamble format includes a long preamble format for extended coverage or a short preamble for basic coverage.

In some implementations, each RACH configuration index corresponds to a set of RACH parameters, the RACH parameters including one or more of: a preamble format, B) a starting symbol, C) a number of PRACH slots in a subframe, D) a number of time domain occasions in the PRACH slots, E) a PRACH duration, or a combination thereof.

In some implementations, to transmit the configuration message the processor 902 coupled with the memory 904 may be configured to, capable of, or operable to cause the NE 900 to transmit a broadcast of minimum system information including the configuration message. In certain implementations, the minimum system information includes a plurality of parameter sets, each parameter set associated with different coverage types or different device types.

In some implementations, the set of threshold includes at least a first set of RSRP based thresholds for selection of the preamble format and a second set of RSRP based threshold for selection of a number of repetition counts associated with transmission of the first RACH preamble.

In some implementations, the processor 902 coupled with the memory 904 may be configured to, capable of, or operable to cause the NE 900 to transmit, to the UE, an indication of TBoMS, and B) receive, from the UE, a PUSCH transmission over multiple slots using a slot bundling technique. In such implementations, the PUSCH transmission may be associated with the first RACH preamble, and a code rate of the PUSCH transmission satisfies a rate threshold.

In certain implementations, the indication of TBoMS includes an implicit indication in a DCI format associated with the first RACH preamble.

In some implementations, the processor 902 coupled with the memory 904 may be configured to, capable of, or operable to cause the NE 900 to transmit a RAR message in response to the first RACH preamble, the RAR message including the indication of TBoMS.

The controller 906 may manage input and output signals for the NE 900. The controller 906 may also manage peripherals not integrated into the NE 900. In some implementations, the controller 906 may utilize an operating system such as iOS®, ANDROID®, WINDOWS®, or other operating systems. In some implementations, the controller 906 may be implemented as part of the processor 902.

In some implementations, the NE 900 may include at least one transceiver 908. In some other implementations, the NE 900 may have more than one transceiver 908. The transceiver 908 may represent a wireless transceiver. The transceiver 908 may include one or more receiver chains 910, one or more transmitter chains 912, or a combination thereof.

A receiver chain 910 may be configured to receive signals (e.g., control information, data, packets) over a wireless medium. For example, the receiver chain 910 may include one or more antennas for receiving the signal over the air or wireless medium. The receiver chain 910 may include at least one amplifier (e.g., a low-noise amplifier (LNA)) configured to amplify the received signal. The receiver chain 910 may include at least one demodulator configured to demodulate the received signal and obtain the transmitted data by reversing the modulation technique applied during transmission of the signal. The receiver chain 910 may include at least one decoder for decoding/processing the demodulated signal to receive the transmitted data.

A transmitter chain 912 may be configured to generate and transmit signals (e.g., control information, data, packets). The transmitter chain 912 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 912 may also include at least one power amplifier configured to amplify the modulated signal to an appropriate power level suitable for transmission over the wireless medium. The transmitter chain 912 may also include one or more antennas for transmitting the amplified signal into the air or wireless medium.

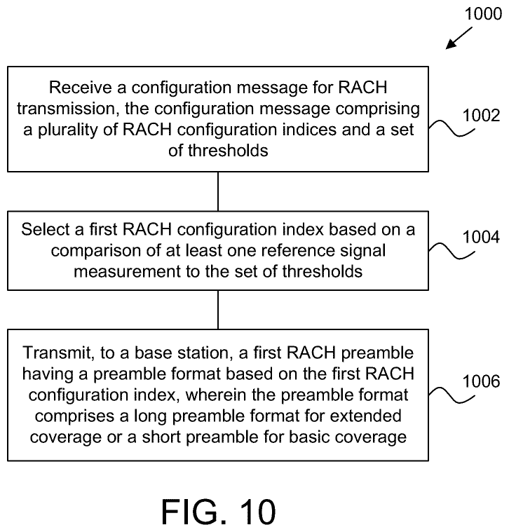

FIG. 10 illustrates a flowchart of a method 1000 in accordance with aspects of the present disclosure. The operations of the method 1000 may be implemented by a UE as described herein. In some implementations, the UE may execute a set of instructions to control the function elements of the UE to perform the described functions.

At step 1002, the method 1000 may include receiving a configuration message for RACH transmission, the configuration message comprising a plurality of RACH configuration indices and a set of thresholds. The operations of step 1002 may be performed in accordance with examples as described herein. In some implementations, aspects of the operations of step 1002 may be performed by a UE, as described with reference to FIG. 7.

At step 1004, the method 1000 may include selecting a first RACH configuration index based on a comparison of at least one reference signal measurement to the set of thresholds. The operations of step 1004 may be performed in accordance with examples as described herein. In some implementations, aspects of the operations of step 1004 may be performed by a UE, as described with reference to FIG. 7.

At step 1006, the method 1000 may include transmitting, to a base station, a first RACH preamble having a preamble format based on the first RACH configuration index, wherein the preamble format comprises a long preamble format for extended coverage or a short preamble for basic coverage. The operations of step 1006 may be performed in accordance with examples as described herein. In some implementations, aspects of the operations of step 1006 may be performed by a UE, as described with reference to FIG. 7.

It should be noted that the method 1000 described herein describes one possible implementation, and that the operations and the steps may be rearranged or otherwise modified and that other implementations are possible.

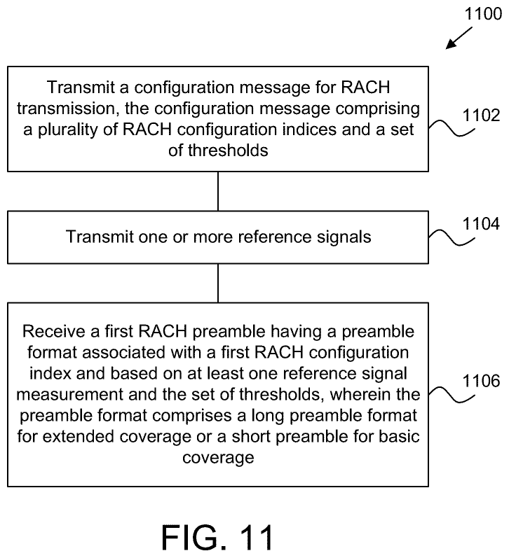

FIG. 11 illustrates a flowchart of a method 1100 in accordance with aspects of the present disclosure. The operations of the method 1100 may be implemented by a base station, such as an NE as described herein. In some implementations, the base station may execute a set of instructions to control the function elements of the base station to perform the described functions.

At step 1102, the method 1100 may include transmitting a configuration message for RACH transmission, the configuration message comprising a plurality of RACH configuration indices and a set of thresholds. The operations of step 1102 may be performed in accordance with examples as described herein. In some implementations, aspects of the operations of step 1102 may be performed by a NE, as described with reference to FIG. 9.

At step 1104, the method 1100 may include transmitting one or more reference signals. The operations of step 1104 may be performed in accordance with examples as described herein. In some implementations, aspects of the operations of step 1104 may be performed by a NE, as described with reference to FIG. 9.

At step 1106, the method 1100 may include receiving a first RACH preamble having a preamble format associated with a first RACH configuration index and based on at least one reference signal measurement and the set of thresholds, wherein the preamble format comprises a long preamble format for extended coverage or a short preamble for basic coverage. The operations of step 1106 may be performed in accordance with examples as described herein. In some implementations, aspects of the operations of step 1106 may be performed by a NE, as described with reference to FIG. 9.

It should be noted that the method 1100 described herein describes one possible implementation, and that the operations and the steps may be rearranged or otherwise modified and that other implementations are possible.

What is claimed is:

1. A user equipment (UE) for wireless communication, comprising:
at least one memory; and
at least one processor coupled with the at least one memory and configured to cause the UE to:
receive a configuration message for random access channel (RACH) transmission, the configuration message comprising a plurality of RACH configuration indices and a set of thresholds;
select a first RACH configuration index based on a comparison of at least one reference signal measurement to the set of thresholds; and
transmit, to a base station, a first RACH preamble having a preamble format based on the first RACH configuration index, wherein the preamble format comprises a long preamble format for extended coverage or a short preamble for basic coverage.

2. The UE of claim 1, wherein each RACH configuration index corresponds to a set of RACH parameters, the RACH parameters comprising one or more of:
a preamble format,
a starting symbol,
a number of physical RACH (PRACH) slots in a subframe,
a number of time domain occasions in the PRACH slots, or
a PRACH duration.

3. The UE of claim 1, wherein to receive the configuration message the at least one processor is configured to cause the UE to:
receive a broadcast of minimum system information comprising the configuration message.

4. The UE of claim 3, wherein the minimum system information comprises a plurality of parameter sets, each parameter set associated with different coverage types or different device types.

5. The UE of claim 1, wherein the set of thresholds comprises at least a first set of reference signal received power (RSRP) based thresholds for selection of the preamble format and a second set of RSRP based threshold for selection of a number of repetition counts associated with transmission of the first RACH preamble.

6. The UE of claim 5, wherein the number of repetition counts associated with each threshold of the second set of thresholds is based on a selected preamble format.

7. The UE of claim 1, wherein the at least one processor is configured to cause the UE to:
determine a code rate for a physical uplink shared channel (PUSCH) transmission associated with the first RACH preamble; and
perform the PUSCH transmission over multiple slots using a slot bundling technique in response to the code rate satisfying a rate threshold.

8. The UE of claim 7, wherein the at least one processor is configured to cause the UE to:
determine the code rate based on the reference signal measurement.

9. The UE of claim 7, wherein the at least one processor is configured to cause the UE to:
receive an indication of transport block processing over multiple slots (TBoMS); and
perform the PUSCH transmission over multiple slots further based on the received indication,
wherein the PUSCH transmission comprises a RACH message 3 (Msg3) or a RACH message A (MsgA).

10. The UE of claim 7, wherein the at least one processor is configured to cause the UE to:
initiate a contention resolution time in response to a transmission of a last transport block in a last slot associated with the PUSCH transmission.

11. A method performed by a user equipment (UE), the method comprising:
receiving a configuration message for random access channel (RACH) transmission, the configuration message comprising a plurality of RACH configuration indices and a set of thresholds;
selecting a first RACH configuration index based on a comparison of at least one reference signal measurement to the set of thresholds; and
transmitting, to a base station, a first RACH preamble having a preamble format based on the first RACH configuration index, wherein the preamble format comprises a long preamble format for extended coverage or a short preamble for basic coverage.

12. A base station for wireless communication, comprising:
at least one memory; and
at least one processor coupled with the at least one memory and configured to cause the base station to:
transmit a configuration message for random access channel (RACH) transmission, the configuration message comprising a plurality of RACH configuration indices and a set of thresholds;
transmit one or more reference signals; and
receive, from a user equipment (UE), a first RACH preamble having a preamble format associated with a first RACH configuration index and based on at least one reference signal measurement and the set of thresholds, wherein the preamble format comprises a long preamble format for extended coverage or a short preamble for basic coverage.

13. The base station of claim 12, wherein each RACH configuration index corresponds to a set of RACH parameters, the RACH parameters comprising one or more of:
a preamble format,
a starting symbol,
a number of physical RACH (PRACH) slots in a subframe,
a number of time domain occasions in the PRACH slots, or
a PRACH duration.

14. The base station of claim 12, wherein to transmit the configuration message, the at least one processor is configured to cause the base station to:
transmit a broadcast of minimum system information comprising the configuration message.

15. The base station of claim 14, wherein the minimum system information comprises a plurality of parameter sets, each parameter set associated with different coverage types or different device types.

16. The base station of claim 12, wherein the set of threshold comprises at least a first set of reference signal received power (RSRP) based thresholds for selection of the preamble format and a second set of RSRP based threshold for selection of a number of repetition counts associated with transmission of the first RACH preamble.

17. The base station of claim 12, wherein the at least one processor is configured to cause the base station to:
transmit, to the UE, an indication of transport block processing over multiple slots (TBoMS); and
receive, from the UE, a physical uplink shared channel (PUSCH) transmission over multiple slots using a slot bundling technique,
wherein the PUSCH transmission is associated with the first RACH preamble, and wherein a code rate of the PUSCH transmission satisfies a rate threshold.

18. The base station of claim 17, wherein the indication of TBoMS comprises an implicit indication in a downlink control information (DCI) format associated with the first RACH preamble.

19. The base station of claim 17, wherein the at least one processor is configured to cause the base station to:
transmit a random access response (RAR) message to the first RACH preamble, wherein the RAR message comprises the indication of TBoMS.

20. A method performed by a base station, the method comprising:
transmitting a configuration message for random access channel (RACH) transmission, the configuration message comprising a plurality of RACH configuration indices and a set of thresholds;
transmitting one or more reference signals; and
receiving a first RACH preamble having a preamble format associated with a first RACH configuration index and based on at least one reference signal measurement and the set of thresholds, wherein the preamble format comprises a long preamble format for extended coverage or a short preamble for basic coverage.
